(19) United States
(12) Patent Application Publication
(10) Pub. No.: US 2011/0302334 A1
(43) Pub. Date: Dec. 8, 2011

(54) Flow Control in Real-Time Transmission of Non-Uniform Data Rate Encoded Video Over a Universal Serial Bus

(76) Inventors: Lakshmi Kantha Reddy Ponnatota, Kurnool District (IN); Chetan Vinchhi, Bangalore (IN)

(21) Appl. No.: 13/118,229

(22) Filed: May 27, 2011

Related U.S. Application Data
(60) Provisional application No. 61/352,040, filed on Jun. 7, 2010.

(51) Int. Cl. G06F 3/00

(52) U.S. Cl. 710/30

(57) ABSTRACT

A method is provided that includes coding pictures by a video encoder in a digital camera to form a compressed video bit stream for real-time transmission to a host digital system coupled to the digital camera by a universal serial bus (USB), wherein an output data rate of the video encoder is at least sometimes higher than an operating data rate of the host digital system, and applying flow control in the digital camera to maintain an output data rate over the USB to the host digital system of the compressed video bit stream below the operating data rate of the host digital system.

### CROSS-REFERENCE TO RELATED APPLICATIONS

This application claims benefit of U.S. Provisional Patent Application Ser. No. 61/352,040, filed Jun. 7, 2010, which is incorporated by reference herein in its entirety.

### BACKGROUND OF THE INVENTION

1. Field of the Invention

Embodiments of the present invention generally relate to a method and apparatus for flow control in real-time transmission of non-uniform data rate encoded video over a universal serial bus.

2. Description of the Related Art

In many applications, digital cameras are connected to a host digital system such as a personal computer, a laptop, a video conferencing system, a surveillance system, a set top box, a television, etc. by a Universal Serial Bus (USB) and stream captured video in real-time to the host digital system over the USB. Such digital cameras may be referred to as USB cameras. Depending on the capabilities of the USB camera, the video may be transmitted to the host digital system as a stream of raw video data, as a stream of video data encoded in MJPEG format (where each picture in a video sequence is separately compressed as a JPEG image), and/or as a stream of video data encoded using block-based video coding standards such as H.264/AVC, MPEG4, etc.

### SUMMARY

Some embodiments of the present invention relate to a method for coding pictures by a video encoder in a digital camera to form a compressed video bit stream for real-time transmission to a host digital system coupled to the digital camera by a universal serial bus (USB), wherein an output data rate of the video encoder is at least sometimes higher than an operating data rate of the host digital system, and applying flow control in the digital camera to maintain an output data rate over the USB to the host digital system of the compressed video bit stream below the operating data rate of the host digital system.

Some embodiments of the present invention relate to a digital camera that includes a video encoder component configured to code pictures to form a compressed video bit stream for real-time transmission to a host digital system connected to the digital camera by a universal serial bus (USB), wherein an output data rate of the video encoder is at least sometimes higher than an operating data rate of the host digital system, and a flow control component configured to apply flow control to maintain an output data rate over the USB to the host digital system of the compressed video bit stream below the operating data rate of the host digital system.

### BRIEF DESCRIPTION OF THE DRAWINGS

Particular embodiments will now be described, by way of example only, and with reference to the accompanying drawings:

FIG. 1 shows a block diagram of a system in accordance with one or more embodiments;

FIG. 2 shows a system flow diagram of a USB camera in accordance with one or more embodiments;

FIG. 3 shows a flow diagram of a method in accordance with one or more embodiments;

FIGS. 4A and 4B show graphs in accordance with one or more embodiments; and

FIG. 5 shows a block diagram of an illustrative digital system in accordance with one or more embodiments.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As used herein, the term “picture” refers to a frame or a field of a frame. A frame is a complete image captured during a known time interval. When a video sequence is in progressive format, the term picture refers to a complete frame. When a video sequence is in interlaced format, each frame is composed of a field of odd-numbered scanning lines followed by a field of even-numbered lines. Each of these fields is a picture. Further, an I-picture is an intra-coded picture, a P-picture is an inter-coded picture predicted from another I-picture or P-picture, e.g., a previous I-picture or P-picture, and a B-picture is an inter-coded picture predicted using two pictures, e.g., a previous I-picture or P-picture and a following I-picture or P-picture. Further, as used herein, a data rate is the rate at which information being generated, transferred, or processed. A data rate may be expressed in terms of an amount of information per unit of time. The units for the amount of information may be bits, bytes, etc. and the unit for time may be milliseconds, seconds, etc. Conversion from a data rate expressed in one unit of information and/or time to a data rate in another unit of information and/or time is well understood.

As was previously mentioned, some USB cameras compress a video sequence using block-based video coding standards such as H.264/AVC, MPEG4, etc. prior to transmitting it to a host digital system over the USB. In general, video coding standards such as MPEG-2, MPEG-4, H.264/AVC, etc. and the standard currently under development, HEVC, define a hybrid video coding technique of block motion compensation (prediction) plus transform coding of prediction error. Block motion compensation is used to remove temporal redundancy between successive pictures (frames or fields) by prediction from prior pictures, whereas transform coding is used to remove spatial redundancy within each block of a picture. In such techniques, pictures may be intra-coded I-pictures or inter-coded P-pictures or B-pictures.

The output of video encoders implementing such standards is bursty in nature, i.e., the number of bits output when an I-picture is coded may be several times larger than the number of bits output when a P-picture or B-picture is coded. Further, I-pictures typically occur much less frequently than P or B-pictures. The standard USB video class (UVC) over USB driver implementation will transfer this non-uniform rate behavior to the USB, and thus to the host digital system. Further, the host digital system may not be able to handle the peak data rates when the USB camera transmits a large number of bytes corresponding to an I-picture followed by smaller numbers of bytes corresponding to P or B-pictures. As a result, the host digital system may drop some of the transmitted data, leading to artifacts in the decoded video stream.

For example, the processing on the host digital system may involve multiple steps, with buffering at each step. More specifically, the host USB driver may receive transmitted data packets from the USB and store the packets in a buffer. The host UVC driver may then retrieve the data packets from this buffer, and process them to extract the compressed video data from the packets. The compressed video data may then be stored in another buffer for further processing such as decoding, storage, etc. If the USB camera transmits the compressed video data non-uniformly, one or more of the buffers on the host digital system may overflow due to throughput limitations on the host digital system, resulting in data errors.

Embodiments described herein provide for flow control in a USB camera that maintains an output data rate of a bursty compressed video bit stream over the USB at or below an operating data rate of a digital system coupled to the USB camera. That is, the flow control receives the bursty compressed video bit stream at the rate at which the bit stream is generated by a video encoder and provides the compressed bit stream to a USB interface in the digital camera at an output data rate that is at or below an operating data rate of the host digital system. An operating data rate of the host digital system may be the highest data rate at which compressed video data may be sent from the USB camera to the host digital system without error, e.g., without truncation or dropping of transmitted video data by the host digital system. The operating data rate of the host digital system may be based in part on the overall throughput of the host digital system in processing compressed video data transmitted by the USB camera, not just the USB bandwidth.

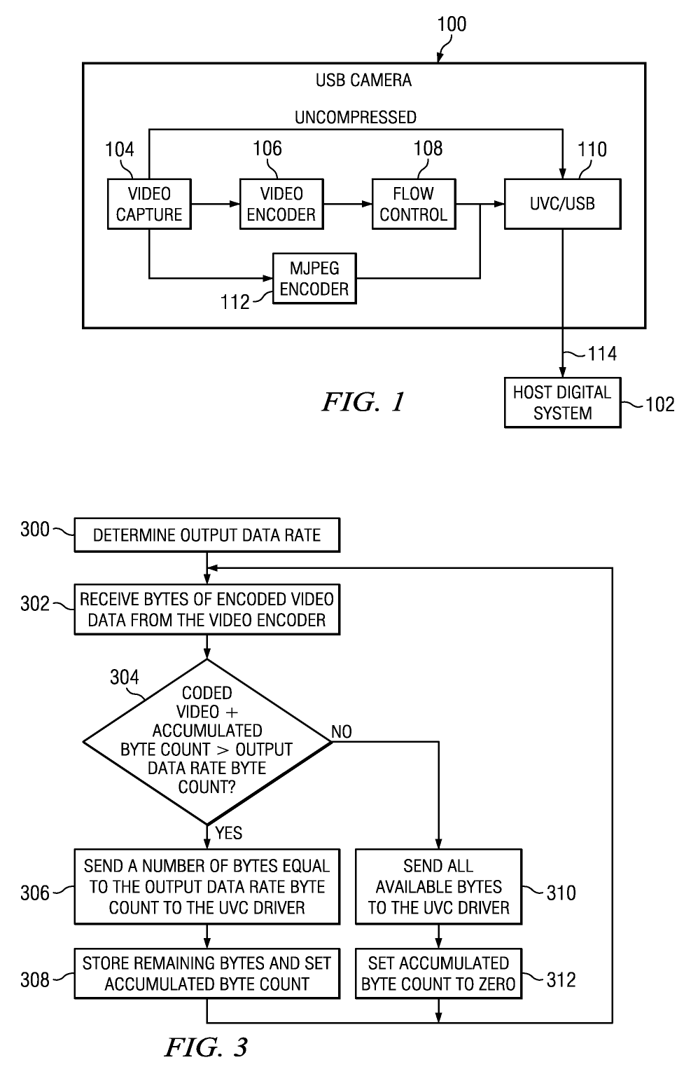

FIG. 1 shows a block diagram of a system in accordance with one or more embodiments. The system includes a digital USB camera 100 connected to a host digital system 102 via a USB 114. The source digital system 100 includes a video capture component 104, a video encoder component 106, a flow control component 108, a UVC/USB component 110, and a MJPEG encoder component 112. These components may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

The video capture component 104 provides a video sequence to one or more of the video encoder component 106, the MJPEG encoder 112, and the USB driver 110. The video capture component 104 may include, for example, a CMOS or CCD image sensor and image processing functionality for converting the signal from the image sensor to a digital signal, dividing the digital signal into frames of pixels, and processing each frame to enhance the image in the frame. As is explained in more detail herein, the frame rate of the video capture component 104, i.e., the number of frames per second produced by the video capture component, may be set during the USB enumeration process. The image processing performed may include one or more image enhancement techniques such as, for example, black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment.

The MJPEG encoder 112 receives the processed frames of a video sequence from the video capture component 104 and codes the frames as per an MJPEG video format. MJPEG or Motion JPEG is an informal name for a class of video formats where each video frame or interlaced field of a digital video sequence is separately compressed as a JPEG image. The MJPEG encoder 112 may include functionality to code in one or more MJPEG video formats. The coded MJPEG frames are then provided to the UVC/USB component 110.

The video encoder component 106 receives the processed video frames from the video capture component 104 and encodes the frames according to a block-based video compression standard. In general, the video encoder component 106 receives the video sequence from the video capture component 104 as a sequence of frames, divides the frames into pictures as needed, divides the pictures into coding blocks, e.g., macroblocks, and encodes the video data in the coding blocks to generate coded pictures, i.e., I-pictures, P-pictures, and B-pictures. The output of the video encoder component 106 is a compressed video bit stream that includes the coded pictures. The compressed video bit stream is generated at a data rate, typically referred to as a bit rate, adapted to a transmission target bit rate. That is, a rate control scheme is used by the video encoder component 106 to adjust various coding parameters to adapt the output bit rate to a target bit rate. As is explained in more detail herein, the target bit rate for the video encoder component 106 may be set during the USB enumeration process. The compressed video bit stream is provided to the flow control component 110.

The video encoder component 106 may include functionality to code the video sequence according to one or more video compression standards such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), the emerging ITU-T/ISO High Efficiency Video Coding (HEVC) standard, etc.

The flow control component 108 receives the compressed video bit stream from the video encoder component 106 at the output data rate of the video encoder component 106, and provides the bit stream in first-in first-out order to the UVC/USB component 110 at an output data rate that the host digital system 102 can successfully process, i.e., that is at or below the operating data rate of the host digital system 102. As is explained in more detail herein, the output data rate may be set during the USB enumeration process. In some embodiments, the output data rate is computed as BR/(FPS*8) bytes per 1/FPS time unit, where BR is the target bit rate of the video encoder component 106 and FPS is the number of frames per second, i.e., frame rate, produced by the video capture component 104.

The output data rate is used by the flow control component 108 to cap the amount of the compressed video bit stream sent to the UVC/USB component 110 in the time unit of the data rate. That is, the output data rate sets the maximum number of bytes of the compressed video bit steam that the flow control component 108 will be send to the UVC/USB component 110 in a given time unit. If there are more available bytes of the compressed video stream than this maximum number, the flow control component 108 accumulates the excess bytes, e.g., stores the bytes in a buffer, to be sent in a subsequent time unit. In some embodiments, the time unit for receiving the compressed bit stream from the video encoder component 106 and the time unit for sending data to the UVC/USB component 110 is based on the frame rate of the video capture component 104. That is, the time unit is the amount of time for producing a frame of image data. For example, if the frame rate is 30 FPS, the time unit is 1/30=33 msecs. Operation of the flow control component 108 is explained in more detail below.

The UVC/USB component 110 receives an uncompressed video bit stream, a MJPEG coded video bit stream, and/or the compressed video bit stream and performs the processing needed to send the bit stream(s) to the host digital system 102. The UVC/USB component 110 includes both a UVC driver and a USB driver. The UVC driver operates according to a UVC definition and processes the bit streams(s) to prepare the data for transmission according to a basic protocol and the appropriate payload format as defined in the UVC definition. For example, if the video encoder component 106 used the H.264 video coding standard, the MPEG-2 TS payload format may be used. The USB driver operates according to a USB standard and performs the appropriate processing to send the UVC payloads in packets to the host digital system 102. The USB standards and UVC definitions are generated and maintained by the USB Implementors Forum, Inc. and are available at www.usb.org.

The host digital system 102 may be any system with functionality to receive a video sequence from the USB camera 100 such as, for example, a personal computer, a set top box, a television, a video conferencing system, etc. The host digital system 102 includes a host USB driver and a host UVC driver (not specifically shown) to receive data from the bus and reverse the UVC/USB processing performed on the USB camera 100 to extract the video bit stream(s) for further processing. The further processing depends on the particular application and capabilities of the host digital system 102.

In operation, a USB enumeration process is performed when the USB camera 100 is connected to a powered USB port on the host digital system 102. As part of the enumeration process, the host digital system 102 receives configuration information from the USB camera 100 and selects a configuration. The possible configurations may include configuring the USB camera to send one of the uncompressed video data, the MJPEG coded video data, or the compressed bit stream from the video encoder component 106, or to send any combination of these. For example, the host digital system may configure the USB camera 100 to send uncompressed video data for real-time presentation on a display device included in the host digital system 102 and a compressed video bit stream from the video encoder component 106 for storage and/or transmission over a network to another digital system.

If the USB camera 100 is configured to send the output of the video encoder component 106, the host digital system 102 may also configure the output data rate of the flow control component 108 such that the output data rate is at or below the operating data rate of the host digital system. In some embodiments, the host digital system 102 may directly specify the desired output data rate. In embodiments where the flow control component 108 computes the output data rate based on the frame rate and the target bit rate as previously described, the host digital system 102 may specify a frame rate for the video capture component 104 and a target bit rate for the video encoder component 106 that will result in the appropriate output data rate for the host digital system 102. The frame rate and the target bit rate specified by the host digital system 102 are then used to configure the output data rate for the flow control component 108.

At the end of the enumeration process, the USB camera 100 is ready for operation. Operation of a USB camera to send uncompressed video data or MJPEG coded video data if so configured is well understood and is not further described. When the USB camera 100 is configured to send a compressed bit stream from the video encoder component 106 to the host digital system 102, as a video sequence is captured by the video capture component 104 according to the specified frame rate, the frames of the video sequence are sent to the video encoder component 106. The video encoder component 106 generates a compressed video bit stream as the frames are received and provides the compressed video bit stream to the flow control component at the output data rate of the video encoder component 106.

At each time unit of the output data rate of the flow control component 108, the flow control component 108 receives the output of the video encoder component 106 generated since the previous time unit. Note that if the time unit is 1/FPS, the output of the video encoder may be one coded picture. As is well known, the first picture in a video sequence is coded as an I-picture. As a result, the number of bytes in the first coded picture from the video encoder component 106 will be larger than the output data rate of the flow control component 108. Accordingly, the flow control component 108 will send a number of bytes of the compressed video bit stream equal to the number of bytes specified by the output data rate, i.e., the output data rate byte count, to the USB/UVC component 110 and will retain the remaining bytes. For example, the flow control component 108 may store the remaining bytes in a first-in, first-out (FIFO) buffer.

At the next time unit, the flow control component 108 again receives the output of the video encoder component 106 generated in the previous time unit. If the total number of new bytes plus the retained bytes is less than or equal to the output data rate byte count, the flow control component 108 sends all of the bytes to the USB/UVC component 110. Otherwise, the flow control component 108 sends a number of bytes equal to the output data rate byte count and retains the remaining bytes. This process continues as long as a video sequence is being captured. In this manner, the flow control component 108 keeps the amount of compressed video data being sent to the host digital system 102 at or below the operating data rate of the host digital system 102.

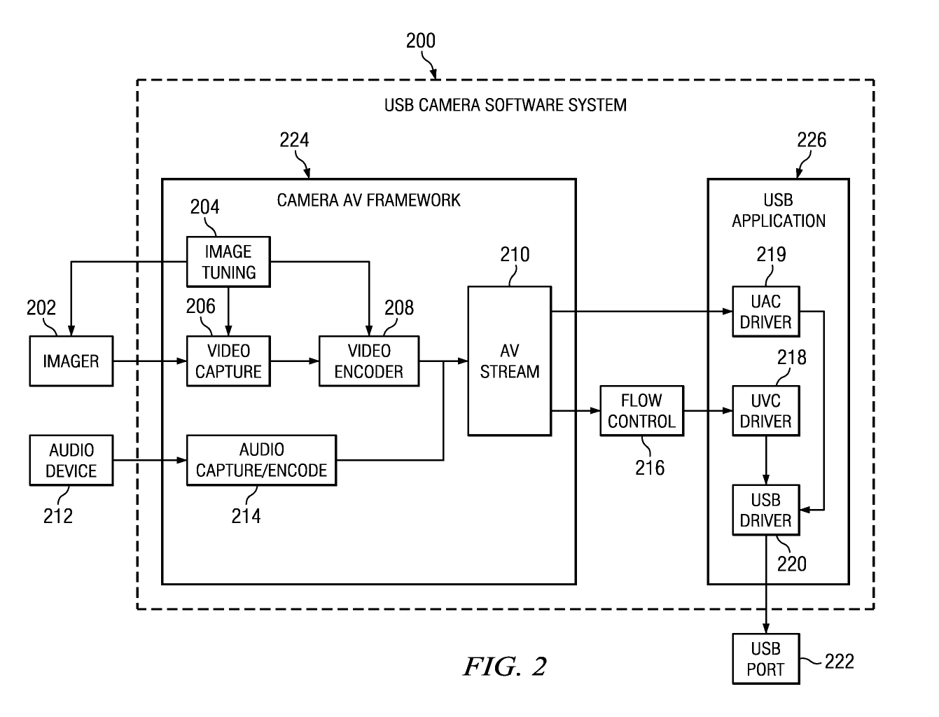

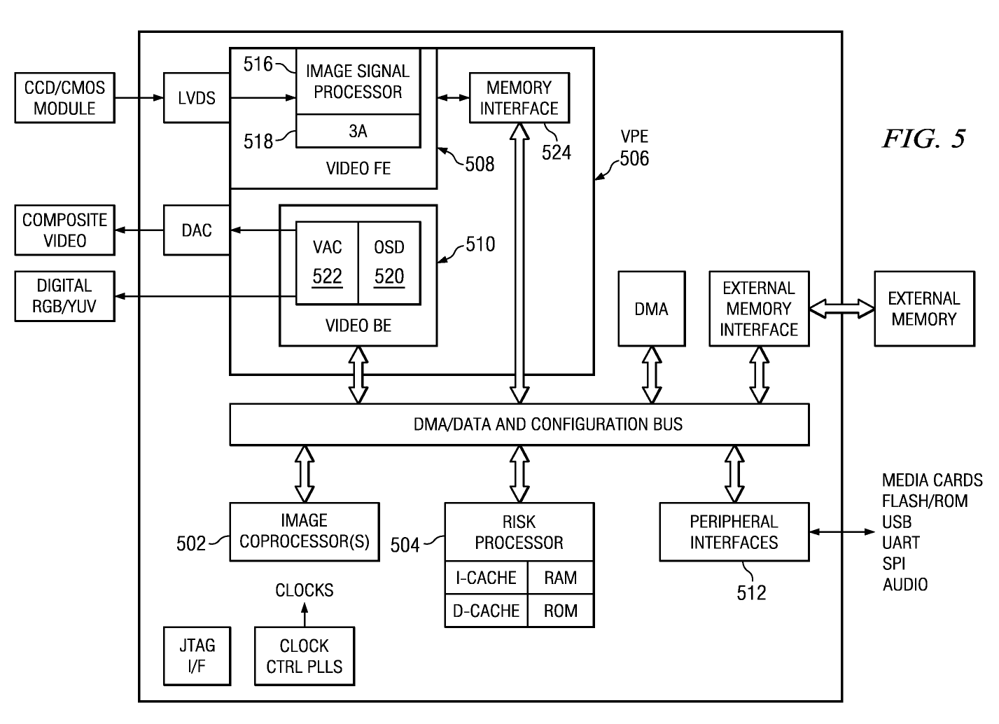

FIG. 2 shows a system flow diagram of a USB camera in accordance with one or more embodiments. More specifically, FIG. 2 illustrates a USB camera software system 200 that executes on the USB camera along with some input and output hardware components of the USB camera. The USB camera software system 200 may be executed in one or more processors (not shown), such as a microprocessor, application specific integrated circuit (ASIC), field programmable gate array (FPGA), or digital signal processor (DSP) in a USB camera. For example, the USB camera software system 200 may execute on an embedded system such as that shown in FIG. 5.

The USB camera software system 200 includes a camera AV (audio/video) framework 224, a flow control module 216, and a USB application 226. The camera AV framework 224 provides an interface and functionality for the capturing, processing, and encoding audio and video data. The camera AV framework includes an image tuning module 204, a video capture module 206, a video encoder module 208, an audio capture/encode module 214, and an AV stream module 210.

The video capture module 206 includes functionality to receive RAW/YUV data from the imager component 202. The imager component 202 may be, for example, a CMOS image sensor with a digital RAW/YUV output. The video capture module 206 includes functionality to divide the digital output of the imager component 202 into frames of pixels. As is explained in more detail herein, the frame rate of the video capture module 206 may be set during the USB enumeration process.

The image tuning module 204 includes functionality to perform one or more image enhancement techniques on frames of pixels generated by the video capture module 206. The image enhancement techniques may include, for example, black clamping, fault pixel correction, color filter array (CFA) interpolation, gamma correction, auto white balancing, color space conversion, edge enhancement, detection of the quality of the lens focus for auto focusing, and detection of average scene brightness for auto exposure adjustment. The image tuning module 204 also includes functionality to adjust parameters in the imager component 202, e.g., lens focus, and/or the video capture component 206 to enhance image quality. The image tuning module 204 may also include functionality to detect human faces in an image and to provide the coordinates of face locations and sizes to the video encoder module 208. The video encoder module may then use this information to allocate more bits to these regions to improve the perceived quality of the faces in an image.

The video encoder module 208 includes functionality to receive processed video frames from the video capture module 206 and to encode the frames according to a block-based video compression standard to generate a compressed video bit stream. In general, the video encoder module 208 includes functionality to receive the video sequence from the video capture module 206 as a sequence of frames, to divide the frames into pictures as needed, to divide the pictures into coding blocks, e.g., macroblocks, and to encode the video data in the coding blocks to generate coded pictures, i.e., I-pictures, P-pictures, and B-pictures. The compressed video bit stream is generated at a data rate, typically referred to as a bit rate, adapted to a transmission target bit rate. That is, a rate control scheme is used by the video encoder module 208 to adjust various coding parameters to adapt the output bit rate to a target bit rate. As is explained in more detail herein, the target bit rate for the video encoder module 208 may be set during the USB enumeration process. The output of the video encoder module 208 is a compressed video bit stream that includes the coded pictures.

The video encoder module also includes functionality to notify the flow control module 216 that compressed video data is available via the AV stream module 210.

The audio capture/encode module 214 includes functionality to receive audio data corresponding to the captured video sequence from the audio device 212 and encode the audio stream according to one or more audio compression standards, such as, for example, G.711, G.723, AAC_LD, G.722 etc. The output of the audio capture/encode module 214 is a compressed audio bit stream. The audio capture/encode module 214 also includes functionality to notify the UAC driver that compressed audio data is available via the AV stream module 210.

The AV stream module 210 includes functionality to receive and buffer the compressed video bit stream from the video encoder module 208 and the compressed audio bit stream from the audio capture/encode module 214. The AV stream module 210 also provides an interface for accessing the buffered bit streams.

The flow control module 216 includes functionality to retrieve the compressed video bit stream from the AV stream module 210 responsive to notification from the video encoder module 208 that data is available and to provide the bit stream in first-in first-out order to the UVC driver module 218 periodically at an output data rate that the host digital system can successfully process i.e., that is at or below the operating data rate of the host digital system. As is explained in more detail herein, the output data rate is set during the USB enumeration process. In some embodiments, the output data rate BR/(FPS*8) bytes per 1/FPS time unit where BR is the target bit rate of the video encoder module 208, FPS is the number of frames per second of the video capture module 206, and 8 is the number of bits in a byte.

The output data rate is used by the flow control module 216 to cap the amount of the compressed video bit stream sent to the UVC driver module 218 at the time unit of the data rate. That is, the output data rate sets the maximum number of bytes of the compressed video bit steam that the flow control module 216 will be send to the UVC driver module 218 in a given time unit. If there are more available bytes of the compressed video stream than this maximum number, the flow control module 216 accumulates the excess bytes, e.g., stores the bytes in a buffer, to be sent in a subsequent time unit. In some embodiments, the time unit for sending data to the UVC driver module 218 is based on the frame rate of the video capture module 206. That is, the time unit is the amount of time for producing a frame of image data. For example, if the frame rate is 30 FPS, the time unit is 1/30=33 msecs. Operation of the flow control module 216 is explained in more detail below.

The USB application 226 includes functionality to control the interaction between the USB camera and a host digital system coupled to the USB camera via the USB port 222. This functionality includes managing the command and configuration information exchange between the camera AV framework 224 and the host digital system. The USB application 226 includes a UAC driver module 219, a UVC driver module 218, and a USB driver module 220.

The UAC driver 219 operates according to a USB Audio class specification. More specifically, the UAC driver 219 includes functionality to retrieve the compressed audio bit stream from the AV stream module 210 responsive to notification from the audio capture/encode module 214 that data is available, to format the compressed audio bit stream as specified in a UAC, and to provide the formatted data to the USB driver 220.

The UVC driver module 218 operates according to a UVC definition and processes the compressed video bit stream received from the flow control module 216 to prepare the data for transmission according to a basic protocol and the appropriate payload format as defined in the UVC definition.

The USB driver module 220 operates according to a USB standard and includes functionality to perform the appropriate processing to send the UVC payloads from the UVC driver module 218 and the formatted audio data from the UAC driver module 219 in packets to the host digital system via the USB port 222.

In operation, a USB enumeration process is performed when the USB camera is connected to a powered USB port on a host digital system. As part of the enumeration process, the host digital system may configure the output data rate of the flow control module 216 such that the output data rate is at or below the operating data rate of the host digital system. In some embodiments, the host digital system may directly specify the desired output data rate. In embodiments where the flow control module 216 computes the output data rate based on the frame rate and the target bit rate as previously described, the host digital system may specify a frame rate for the video capture module 206 and a target bit rate for the video encoder module 208 that will result in the appropriate output data rate for the host digital system. The frame rate and the target bit rate specified by the host digital system are then used to configure the output data rate for the flow control module 216.

At the end of the enumeration process, the USB camera is ready for operation. As a video sequence is captured by the imager 202 and the video capture module 206 according to the specified frame rate, the frames of the video sequence are sent to the video encoder module 208. The video encoder module 208 generates a compressed video bit stream as the frames are received and provides the compressed video bit stream to the AV stream component 210, notifying the flow control module 216 when video data is stored in the AV stream component 210.

Responsive to notifications by the video encoder module 208, the flow control module 216 retrieves compressed video data from the AV stream module 216 and provides the data to the UVC driver module 218 at the output data rate. If the amount of video data stored in the AV stream module 210 is larger than the output data rate byte count, the flow control module retrieves a number of bytes from the AV stream module 216 equal to the output data rate byte count and provides the retrieved compressed video data to the UVC driver 218. Otherwise, the flow control module retrieves all available compressed video data from the AV stream module 210 and provides it to the UVC driver module 218. This process continues as long as a video sequence is being captured. In this manner, the flow control module 216 keeps the amount of compressed video data being sent to the host digital system at or below the operating data rate of the host digital system.

The UVC driver module 218 processes the compressed video data received from the flow control module 216 according to the UVC definition to generate payloads and provides the payloads to the USB driver module 220.

As the video sequence is captured, an audio sequence may simultaneously be captured by the audio device 212 and compressed by the audio capture/encode module 214. The compressed audio bit stream is provided to the AV stream component 210, and the UAC driver 219 is notified by the audio capture/encode module 214 when audio data is stored in the AV stream component 210. The UAC driver 214 retrieves the compressed audio data from the AV stream module 210, formats the data, and provides it to the USB driver 220.

The USB driver module 220 packetizes the payloads form the UVC driver module 218 and the formatted audio data from the UAC driver module 219, and sends the packets to the host digital system via the USB port 222.

FIG. 3 is a flow diagram of a method for flow control in the real-time transmission of non-uniform data rate encoded video from a digital camera to a host digital system over a USB in accordance with one or more embodiments. Initially, an output data rate is determined 300. In some embodiments, the output data rate may be specified by the host digital system as part of the USB enumeration process. In some embodiments, the output data rate is determined based on a frame rate and a target bit rate selected for the digital camera by the host digital system as part of the USB enumeration process. In some such embodiments, the output data rate is computed as BR/(FPS*8) bytes per 1/FPS time unit.

Once the output data is determined, steps 302-312 are performed at the time units of the output data rate as a video sequence is captured and encoded by the digital camera. The time interval may be based on the frame rate selected by the host digital system. At each time unit, bytes of encoded video data are received from the video encoder in the digital camera 302. If the number of coded video data bytes received plus the accumulated byte count is greater than the output data rate byte count 304, then a number of bytes of coded video data equal to the output byte count are sent to the UVC driver in the digital camera 306. The remaining coded video data bytes are stored and the accumulated byte count is set to the number of remaining coded video bytes 308. Note that initially there will be no stored coded video data bytes and the accumulated byte count will be zero.

If the number of coded video data bytes received plus the accumulated byte count is not greater than the output byte count 304, then all available coded video data bytes, i.e., all stored coded video data bytes and all of the received coded video data bytes, are sent to the UVC driver (310) and the accumulated byte count is set to zero 312.

While the above embodiments are described as using the UVC protocol for sending compressed video data over a USB to a host digital system, one of ordinary skill in the art will understand other embodiments that may use other protocols for sending the compressed video data.

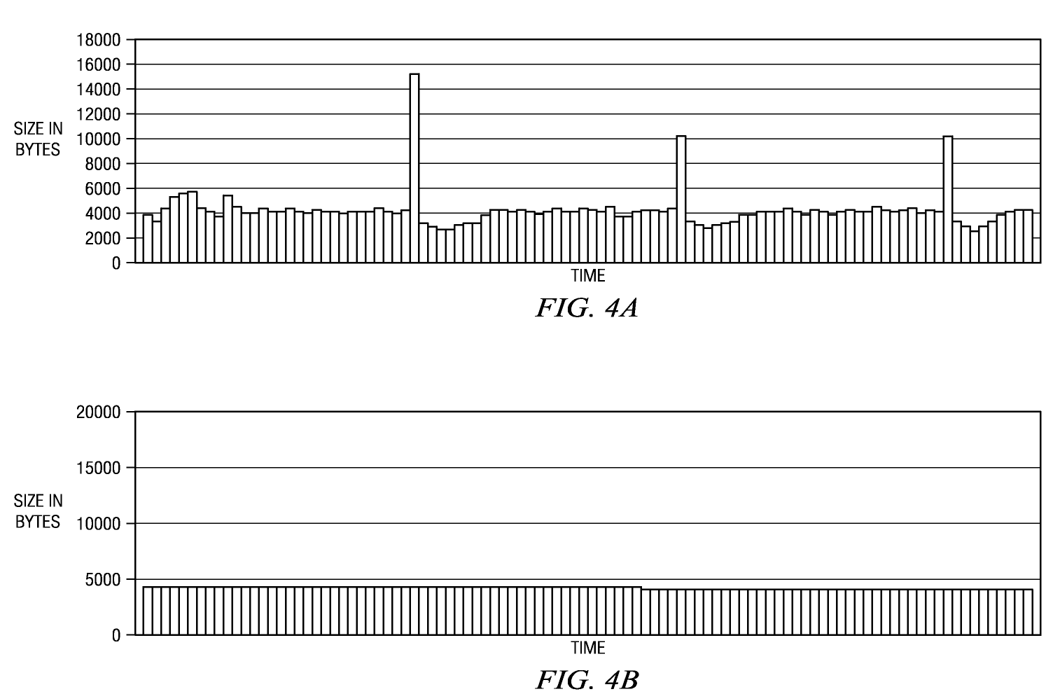

FIGS. 4A and 4B show graphs depicting, respectively, the actual output data rate of an H.264 video encoder over 100 frames of a video streaming without flow control and the output data rate with flow control for the same 100 frames. As can be seen in FIG. 4A, there are periodic peaks in the output data rate. These peaks correspond to I-pictures output by the video encoder. In this example, the number of bytes in an I-picture is approximately 2-3 times the number of bytes in the inter-predicted pictures. As was previously explained, these peaks in the output data rate may cause the I-frame data to be lost or truncated by a host digital system receiving the data, causing artifacts in the decoded video. As can be seen in FIG. 4B, using flow control as described herein tends to make the output data rate more uniform on the USB.

As was previously mentioned, techniques described herein may be implemented entirely or partially in software. The software instructions may be initially stored in a computer-readable medium such as compact disc (CD), a diskette, a tape, a file, memory, or any other computer readable storage device, and loaded and executed by a processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

FIG. 5 shows a block diagram of an embedded digital system suitable for use in a USB camera which may be configured to perform flow control as described herein. The digital system of FIG. 5 includes, among other components, one or more DSP-based image coprocessors (ICP) 502, a RISC processor 504, and a video processing engine (VPE) 506. The RISC processor 504 may be any suitably configured RISC processor. The VPE 506 includes a configurable video processing front-end (Video FE) 508 input interface used for video capture from imaging peripherals such as image sensors, video decoders, etc., a configurable video processing back-end (Video BE) 510 output interface used for display devices such as SDTV displays, digital LCD panels, HDTV video encoders, etc, and memory interface 524 shared by the Video FE 508 and the Video BE 510. The digital system also includes peripheral interfaces 512 for various peripherals that may include a multi-media card, an audio serial port, a Universal Serial Bus (USB) controller, a serial port interface, etc.

The Video FE 508 includes an image signal processor (ISP) 516, and a 3A statistic generator 3A) 518. The ISP 516 provides an interface to image sensors and digital video sources. More specifically, the ISP 516 may accept raw image/video data from a sensor (CMOS or CCD) and can accept YUV video data in numerous formats. The ISP 516 also includes a parameterized image processing module with functionality to generate image data in a color format (e.g., RGB) from raw CCD/CMOS data. The ISP 516 is customizable for each sensor type and supports video frame rates for preview displays of captured digital images and for video recording modes. The ISP 516 also includes, among other functionality, an image resizer, statistics collection functionality, and a boundary signal calculator. The 3A module 518 includes functionality to support control loops for auto focus, auto white balance, and auto exposure by collecting metrics on the raw image data from the ISP 516 or external memory.

The Video BE 510 includes an on-screen display engine (OSD) 520 and a video analog encoder (VAC) 522. The OSD engine 520 includes functionality to manage display data in various formats for several different types of hardware display windows and it also handles gathering and blending of video data and display/bitmap data into a single display window before providing the data to the VAC 522 in YCbCr format. The VAC 522 includes functionality to take the display frame from the OSD engine 520 and format it into the desired output format and output signals required to interface to display devices. The VAC 522 may interface to composite NTSC/PAL video devices, S-Video devices, digital LCD devices, high-definition video encoders, DVI/HDMI devices, etc.

The memory interface 524 functions as the primary source and sink to modules in the Video FE 508 and the Video BE 510 that are requesting and/or transferring data to/from external memory. The memory interface 524 includes read and write buffers and arbitration logic.

The ICP 502 includes functionality to perform computational operations required for video encoding of captured images. The video encoding standards supported may include, for example, one or more of the JPEG standards, the MPEG standards, and the H.26x standards. In one or more embodiments, the ICP 502 is configured to perform the computational operations of flow control as described herein as the coded video data is transmitted in real-time over a USB.

The steps in the flow diagrams herein are described in a specific sequence merely for illustration. Alternative embodiments using a different sequence of steps may also be implemented without departing from the scope and spirit of the present disclosure, as will be apparent to one skilled in the relevant arts by reading the disclosure provided herein.

While the invention has been described with respect to a limited number of embodiments, those skilled in the art, having benefit of this disclosure, will appreciate that other embodiments can be devised which do not depart from the scope of the invention as disclosed herein.

What is claimed is:

1. A method comprising:
coding pictures by a video encoder in a digital camera to form a compressed video bit stream for real-time transmission to a host digital system coupled to the digital camera by a universal serial bus (USB), wherein an output data rate of the video encoder is at least sometimes higher than an operating data rate of the host digital system; and
applying flow control in the digital camera to maintain an output data rate over the USB to the host digital system of the compressed video bit stream below the operating data rate of the host digital system.

2. The method of claim 1, wherein the operating data rate is a highest data rate at which the compressed video bit stream may be sent to the host digital system without error.

3. The method of claim 1, wherein the output data rate is based on a frame rate of the digital camera and a target bit rate of the video encoder.

4. The method of claim 3, wherein the output data rate is computed as BR/(FPS*8) bytes per 1/FPS time unit wherein BR is the target bit rate and FPS is the frame rate.

5. The method of claim 1, wherein applying flow control comprises:
receiving a plurality of bytes of the compressed video bit stream from the video encoder;
sending a number of bytes of the compressed video bit stream equal to a number of bytes of the output data rate to the host digital system when a number of bytes in the plurality of bytes and a number of accumulated bytes of the compressed video bit stream is larger than the number of bytes of the output data rate; and
sending the plurality of bytes and the accumulated bytes to the host digital system when the number of bytes in the plurality of bytes and the number of accumulated bytes is not larger than the number of bytes of the output data rate.

6. The method of claim 1, wherein the video encoder is an H.264 video encoder.

7. A digital camera comprising:
a video encoder component configured to code pictures to form a compressed video bit stream for real-time transmission to a host digital system connected to the digital camera by a universal serial bus (USB), wherein an output data rate of the video encoder is at least sometimes higher than an operating data rate of the host digital system; and
a flow control component configured to apply flow control to maintain an output data rate over the USB to the host digital system of the compressed video bit stream below the operating data rate of the host digital system.

8. The digital camera of claim 7, wherein the operating data rate is a highest data rate at which the compressed video bit stream may be sent to the host digital system without error.

9. The digital camera of claim 7, wherein the output data rate is based on a frame rate of the digital camera and a target bit rate of the video encoder.

10. The digital camera of claim 9, wherein the output data rate is computed as BR/(FPS*8) bytes per 1/FPS time unit wherein BR is the target bit rate and FPS is the frame rate.

11. The digital camera of claim 7, wherein the flow control component is further configure to apply flow control by:
receiving a plurality of bytes of the compressed video bit stream from the video encoder;
sending a number of bytes of the compressed video bit stream equal to a number of bytes of the output data rate to the host digital system when a number of bytes in the plurality of bytes and a number of accumulated bytes of the compressed bit stream is larger than the number of bytes of the output data rate; and
sending the plurality of bytes and the accumulated bytes to the host digital system when the number of bytes in the plurality of bytes and the number of accumulated bytes is not larger than the number of bytes of the output data rate.

12. The digital camera of claim 7, wherein the video encoder is an H.264 video encoder.

13. A computer readable medium storing instructions, wherein execution of the instructions by a processor in a digital camera causes the digital camera to perform the actions of:
coding pictures to form a compressed video bit stream for real-time transmission to a host digital system coupled to the digital camera by a universal serial bus (USB), wherein an output data rate the compressed video bit stream is at least sometimes higher than an operating data rate of the host digital system; and
applying flow control to maintain an output data rate over the USB to the host digital system of the compressed video bit stream below the operating data rate of the host digital system.

14. The computer readable medium of claim 13, wherein the operating data rate is a highest data rate at which the compressed video bit stream may be sent to the host digital system without error.

15. The computer readable medium of claim 13, wherein the output data rate is based on a frame rate of the digital camera and a target bit rate of the video encoder.

16. The computer readable medium of claim 15, wherein the output data rate is computed as BR/(FPS*8) bytes per 1/FPS time unit wherein BR is the target bit rate and FPS is the frame rate.

17. The computer readable medium of claim 13, wherein applying flow control comprises:
receiving a plurality of bytes of the compressed video bit stream;
sending a number of bytes of the compressed video bit stream equal to a number of bytes of the output data rate to the host digital system when a number of bytes in the plurality of bytes and a number of accumulated bytes of the compressed video bit stream is larger than the number of bytes of the output data rate; and
sending the plurality of bytes and the accumulated bytes to the host digital system when the number of bytes in the plurality of bytes and the number of accumulated bytes is not larger than the number of bytes of the output data rate.

18. The computer readable medium of claim 13, wherein the pictures are coded according to an H.264 video compression standard.
